(19) United States
(12) Patent Application Publication
(10) Pub. No.: US 2026/0057109 A1
(43) Pub. Date: Feb. 26, 2026

(54) METHOD AND SYSTEM FOR RE-ASSOCIATING ANONYMISED DATA WITH A DATA OWNER

(71) Applicant: MEDICEUS DADOS DE SAÚDE S.A., LISBOA (PT)

(72) Inventors: Peter Villax, LISBOA (PT); André PV Pita, LISBOA (PT)

(73) Assignee: MEDICEUS DADOS DE SAÚDE S.A., LISBOA (PT)

(21) Appl. No.: 18/997,553

(22) PCT Filed: Nov. 10, 2023
(86) PCT No.: PCT/EP2023/081425

§ 371 Date: Jan. 22, 2025

(30) Foreign Application Priority Data
Nov. 14, 2022 (PT) PT 118342

(51) Int. Cl. G06F 21/62; G06F 21/60

(52) U.S. Cl. CPC G06F 21/6254; G06F 21/602

(57) ABSTRACT

A computer-implemented method for re-associating anonymised data with a data owner is described, wherein the data owner has an associated personal code. The method comprises the steps of accessing by a third-party computer the anonymised data stored in a service provider computer server and transferring a first form of the personal code from the third-party computer to the service provider computer server. The method further comprises matching the first form of the personal code with a second form of the personal code at the service provider computer server and transferring the second form of the personal code from the service provider computer server to a user identification data computer server. The method further comprises matching the second form of the personal code to a data owner identifier by the user identification data computer server.

### FIELD OF THE INVENTION

This application claims priority of Portuguese Patent Application number PT118342, filed on 14 Nov. 2022. The entire disclosure of the Portuguese Patent Application number PT118342 is hereby incorporated herein by reference.

The field of the invention relates to a method and system for re-associating anonymised data with a data owner. The present invention is in the field of computer systems and cryptography and reconciles conflicting needs to identify securely and selectively, deidentify and reidentify previously deidentified data owners and their personal data, depending on the identity and function of the recipient of the data.

### BACKGROUND OF THE INVENTION

The proposed European Union Regulation on a European Health Data Space published May 3, 2022, describes rigorous conditions for the protection of personal health data and the privacy rights of citizens, based on the deidentification of the data, as well as other measures. The deidentification of data includes anonymisation, where the data is irreversibly anonymised and it is impossible to trace the data back to its data owner, and pseudonymisation, where the data is anonymised for persons who have no need to know the data owner's identity, but can be subsequently reidentified and re-associated with the data owner if there is a need to know the identity of the data owner or to contact him.

The proposed Regulation indicates two different uses for the data: for primary use, when the data is health data and is used for the treatment of a disease and health of the data owner, or for secondary use, which includes all other uses, including the creation of new knowledge via the large-scale processing of the health data from many different data owners.

Ways of achieving the identification and the deidentification of the data owners are known. The prior art describes methods to identify and deidentify the data, namely WO 2020/221778 and WO 2020/165174.

There is a need to make the deidentification process so secure that identity leaks will be avoided within the data transmission circuit between the data subject or data owner or patient, data providers who store and share the data owner's personal data, service providers who receive, store, manage and share the data owner's personal data, third-parties such as researchers and data experts, who receive the data owner's personal data for further processing, and user identification data processors who can reidentify the data owners. The method must be so secure that even if there is collusion between members of the data circuit, it will be impossible for persons or computers who do not have a need to know the data owner's identity, to reidentify the data which had been previously deidentified. The reidentification of such previously deidentified data must be possible if and only if a) there is a valid reason to do such reidentification of the data and this valid reason can be either legal or ethical or is in line with the consent or request expressed by the data owner and b) reidentification of the data only occurs for authorised recipients of the reidentified data and the reidentification method continues to shield the data owner's identity from all other persons who have no need to know it.

The prior art, however, does not disclose a system or method for re-associating previously anonymised data with the data owner.

### SUMMARY OF THE INVENTION

The present invention solves the technical problem that deidentification and reidentification are essentially conflicting requirements. One of the most effective protection measures in processing personal data is to deidentify the data so that unauthorised third-parties, such as computer technicians or researchers with an interest in the data and who have no need to know the identity of the data owners are prevented from accessing their identity details and their identified data. The health data that is transmitted to the patient's health care professional during a consultation must, however, be clearly identified with the patient's name and the date of birth, so that the health care professional can be sure that the patient is being treated with their own health data, and not another patient's health data. It is therefore necessary to reidentify or re-associate the patient's data with the owner's name with the necessary care to prevent revealing the identified health data to unauthorised third-parties or persons.

The health data must be deidentified so that the owners' identity is protected in another scenario, in which the patient's health data is included in a large population dataset and is sent to a third-party such as a researcher for scientific research purposes. The researcher must not have any information about that patient's name or other features which might identify the patient. In certain cases, however, such as when the researcher, by accessing and processing the dataset discovers new vital information about a patient's health, or diagnosis, or prescription that must be communicated to the patient's health care professional for action, then there must be means to reidentify the concerned patient. The present disclosure reconciles these conflicting needs.

Uses of the present invention are not limited to health data. The uses can include all data systems where personal and personally sensitive data is stored and processed, and there is a need to confirm that the data does indeed belong to the data owner, and enable identification, deidentification and reidentification. An example is in voting and elections, where there are several needs concerning the electoral data: a) to register the citizen or data owner for electronic voting; b) to confirm the citizen's identity and eligibility to vote; c) to enable the electronic means to allow the citizen to vote on election day; d) to duly record that an identified citizen has voted; and e) to duly record the citizens' vote choice, without any association to the citizen's name, so that the vote is as secret as a paper ballot.

Other uses include all situations where there is a need to process data that belongs to sensitive categories of data, such as racial or ethnic origin, political opinions, religious or philosophical beliefs, trade union membership, genetic data or biometric data for the purpose of uniquely identifying a natural person or data owner, data concerning a natural person's sex life and sexual orientation, as well as data where people have a legal right or an expectation of privacy, such as money, banking, taxes, assets, property records, and even in situations where people who have joined social networks want to be known to their friends and are comfortable sharing data with them, but also want to be absolutely anonymous and be able to block any sharing of their data outside the group.

The described technical problem is solved by a method and system of re-associating anonymised data with a data owner, where the data of interest initially resides in data provider computer servers operated by governments, businesses, or health care organisations. The method includes the data owner using a personal software application on a personal computer device, which sends a request to the data provider computer server, instructing that the data owner's data of interest be de-identified and periodically copied to a service provider computer server selected by the data owner. In a health care scenario, citizens' health data may be dispersed and stored across a large number of hospital servers, making access and data sharing difficult or impossible. In order to solve this problem, the European Health Data Space Regulation gives the citizen the right to designate a service provider which will manage their health data and enable easy access and data sharing for the citizen, for health care professionals and for scientific researchers. In non-health care scenarios, the service provider may be the organization responsible for managing the citizen's personal data. At the same time and in order to allow for reidentification in the future, the name, other personal identifiers and contact data of the data owner are transmitted to a separate user identification data computer server. Deidentified data of interest can then be transmitted by the service provider computer server to third-party computers, where specialized processing can be carried out on the data of interest that can produce additional, new information. In certain situations, there may be a need to re-associate this additional information with the name and personal identifiers of the original data owner. This re-association takes place through the collaborative operation of the computing devices, servers and computers described in the present description.

According to a first aspect of the invention, a computer-implemented method for re-associating anonymised data with a data owner is described, wherein the data owner is associated with three cryptographic keys, k1, k2 and k3, collectively referred as the data owner's Global Confidential Identifier.

These keys are generated by the personal software application when it is first installed. Key k1 always remains in the personal software application, key k2 is transmitted to the service provider computer server and key k3 is transmitted to the data provider computer server, to the user identification data computer server and to the service provider computer server, and subsequently by the service provider computer server to the third-party computer. Key k3 will be the data owner's personal code, a pseudonym which identifies the user's data of interest in the absence of the person's name and personal identification details and which allows subsequent reidentification.

The method comprises the step of receiving, by the data provider computer server, a request from the personal software application to search, obtain, deidentify and periodically transmit to the service provider computer server the data owner's data of interest, where the data is exclusively identified by key k3.

The method further comprises receiving, by the service provider computer server, the anonymised data of interest from the data provider computer server, where the data is identified exclusively by key k3. It further comprises the step of receiving by the third-party computer the anonymised data of interest from the data provider computer server, where the data is identified exclusively by key k3, and where the data is subject to a data processing step which produces a useful result.

The method further comprises the step of receiving by the user identification data computer server a request by the third-party computer to reidentify the anonymous useful result, the anonymous data owner's information, and records of interest, where they are exclusively identified with key k3. It further comprises the step of receiving by the data owner's personal software application and by the computer systems of authorised parties who have a lawful need and reason to know, the useful result concerning the data owner as well as their information and records of interest, from the service provider computer server, this time reidentified with the data owner's name and personal identification details.

The data owner identifier can at least be one of a name and further personal identifiers of the data owner.

The step of accessing the anonymised data can further comprise the step of obtaining a need to associate the anonymised data with the data owner's identity.

Key k1 can be a private asymmetric cryptographic key of the data owner. Key k2 can be a public asymmetric cryptographic key of the data owner. Key k3 can be a hashed function of the public asymmetric cryptographic key k2, or a randomly generated number which is recorded in a computer file as being associated with key k2.

A system for re-associating anonymised data with a data owner is further described in this document. The system comprises a service provider computer server for storing anonymised data, matching key k3 to key k2, and transferring key k3 to a user identification data computer server. The system further comprises a third-party computer for accessing the anonymised data and for transferring key k3 to the user identification data computer server for matching key k3 with a data owner identifier, such as name and/or other personal identifiers.

The system can further comprise a data provider computer server for transferring the anonymised data of interest to the service provider computer server.

The system can further comprise a personal computing device of the data owner for generating keys k1, k2 and k3 of the data owner's Global Confidential Identifier. The keys k2 and k3 are transmitted to the service provider computer server and key k3 is subsequently transmitted to the computer of a third-party, where, in the absence of any record of the name or other personal identifiers, the key k3 identifies the data owner's personal data anonymously and confidentially. Key k3 and the data owner's name and personal identifiers are also transmitted to the data provider computer server, where they are used to search, obtain, and confidentially identify the data owner's data of interest, as well as to the user identification data computer server, where they will be stored for the purpose of reidentification at a later data. Therefore, the service provider computer server is the only server storing keys k2 and k3 and the data of interest, while the user identification data computer server is the only server storing key k3, the data owner's name, personal identifiers and contact details, but no other data of interest. This segregation of data is key to ensuring privacy-by-design confidentiality, but also to enable data owner reidentification in case of need.

The method can be used for storage of at least one of health data and electoral data.

A computer program is further described which comprises instructions which, when the program is executed by a computer, cause the computer to carry out the method.

A computer-readable medium is further described which comprises instructions which, when executed by a computer, cause the computer to carry out the method.

The system and method set out in this document provide selectively reversible and irreversible anonymisation. The system processes the data of the data owner, also referred to as citizen, data subject, user, or patient in health scenarios. It is the data owner who governs access to its personal data, requests data transmissions to parties who are storing the data owner's personal data with the objective that a copy be transmitted to a service provider of the data owner's choice, or that the personal data be processed for a purpose with which the data owner agrees. Whenever the law defines conditions for personal data processing, it is desirable to confirm the data owner's identity, via the data owner identifier, such as its name and/or further personal identifiers available, such as date of birth, address, post code, email address, telephone number, citizen number, social security number, national insurance number, tax identification number, etc, which are contained in official documents or are from trusted sources. Other personal identifiers may include usernames, nicknames, financial account numbers, name of employers and of insurance companies.

A personal software application running on the data owner's personal computing device is managed by the data owner and is used to confirm the data owner's identification data and to record the data owner's authorisations, preferences, and data transmission requests. The personal software application is where the data owner indicates what type of personal data can be shared, with whom and for how long; or who can process the personal data, and for what purposes. This is the data owner's expression of consent, and in line with the law, it is as easy to withdraw as it was to grant by the data owner and the personal software application must support this grant and withdrawal of the consent.

When the personal software application is first installed in a data owner's personal computing device, the personal software application, which includes a cryptographic software module, generates cryptographic keys k1, k2 and k3 which identify and encrypt the data owner's identification, but also serve to identify the data owner uniquely and confidentially, in the absence of the name and further personal identifiers. These cryptographic keys are used for subsequent anonymous identification as well as the reidentification or the re-association of the personal data to the name of its owner when needed.

The user identification data computer server, which is operated in one aspect by a public entity (or under the control of the public entity), stores the data owner's name and/or further personal identifiers, the data owner's personal code k3, preferences, authorisations and the data owner's request that its personal data be transmitted to a service provider of choice or processed for a purpose with which the data owner agrees or for which there is a legal purpose. Under the EU General Data Protection Regulation (GDPR), the entity managing the user identification data computer server is the data controller for the personal identification data received. This server propagates the data owner's request and full identification data to all data providers computer servers. At the end of data transmission cycle, it is this user identification data computer server that receives, validates and executes requests for data owner reidentification.

The data provider computer server, which receives the data from the personal software application or from the user identification data computer server, stores at least the data owner's name and/or further personal identifiers, the data owner's key k3 and the data owner data transmission request. The data provider computer server searches the data owner's data of interest contained in the data provider data bases and application computer servers, obtains the data of interest, removes the name and/or all other personal identifiers from the data records, replaces the personal identifiers with the data owner's key k3 and periodically sends the deidentified data records of interest to the data owner's chosen service provider computer server.

The service provider computer server can be controlled by a private or public entity, depending on the data owner's choice. The service provider computer server receives the data owner's data of interest from the data provider computer server, identified only with the data owner's key k3. The service provider computer server has therefore no information about the data owner's name and/or further personal identifiers and has no means to know the data owner's name and personal identifiers. The user's personal data is irreversibly anonymised for the service provider computer server. The service provider computer server stores the data owner's data of interest and may upload the data of interest to the data owner's personal computing device or personal software application for local use or transmit the deidentified data to the computers of third-parties for further processing. Under the GDPR, the service provider entity is the data controller for the data owner's data records of interest received.

The third-party computer receives the data owner's data individually or as part of large datasets, where the data records to be used for further processing with a view to obtain a useful result, are identified exclusively with the respective data owner's key k3 and are therefore anonymised. In this case as well, the data owner's data is irreversibly anonymised, as means to reidentify it are absent from the third-party computer. If there is a need to reidentify the data owner, the data owner's key k3 as well as other information of interest such as the useful result must be sent to the user identification data computer server.

All computer devices, servers and systems of the present disclosure comprise in their software applications data exchange software applications and cryptographic software modules configured to securely and confidentially transmit and receive data to and from the connected computer devices, servers, and systems and to encrypt, decrypt and digitally sign the data. They may be physical servers or operate in the cloud.

The use of data owner personal codes, cryptographic keys and associated selective masking of data owner identities, the use of encryption and decryption, the segregation of data processing functions between different types of computer servers controlled and managed by different legal entities, the use of data minimisation techniques so that only information that is relevant for each type of computer processing action is sent to the respective computer executing the respective computer processing action combine to provide for a very high level of security. The programmes running in the computer systems of the various agents described above control whether the identity of the data owners is selectively revealed or hidden.

Selectively reversible and irreversible anonymisation, or “strong pseudonymisation”, creates the conditions for reidentification being available only to authorised parties. This function is directed to the data operators as well as the third-parties engaged in further processing to discover new information using data owner's data, as the data operators as well as third-parties may generate information that is even more sensitive than the original data they started with. For instance, researchers may find that the data owner belongs to a risk group that makes the data owner more prone to suffer in the future from a serious disease and consequently decrease the data owner's employment potential; or an insurance company may discover that an insured data owner's risk classification needs to be changed which may lead to the policy premium being increased.

It is therefore desirable to prevent any of the computers used by researchers or technicians engaging in the further processing of the personal data, to access the name of the data owner and/or any other personal identifier of the data owner, or to collaborate or illegally collude with one other party operating a computer server of the presently described system to attempt to reidentify the data owner. In order to prevent this, the amount of information available to each operator and its computer system, and even to two colluding operators and their computer systems pooling their data, must be insufficient to allow a successful reidentification of the data owner. At least three different entities or operators running different computers or computer servers must cooperate to achieve data owner and data reidentification, in a way that only the authorised entity's computer system has access to the final disclosure of the data owner's name and/or further personal identifiers. These three entities are the user identification data entity, the service provider entity and the third-party engaged in further processing of the data. Each of these three entities operates a computer system containing one piece of information that is needed by the other computer systems for useful reidentification.

It should be noted that the data provider computer server contains the same identification data for each of the data owners as the user identification data computer server-name, personal identifiers and the key k3—but only the user identification data computer server contains complete and verified name and contact data for the data owner, making it the ideal system for transmitting reidentified information of interest to persons or entities who have a need to obtain the reidentified information. In any case, the fact that the data provider computer server also stores the data owner's name and therefore has a part of the means to reidentify new information resulting from the further processing of the personal data does not alter a part of the present disclosure, which is that at least three computer systems must collaborate to reidentify a deidentified data owner and its data.

In this process, the level of security is determined by the sophistication and complexity of the encryption system, of the encryption keys k1, k2 and k3 generated in the data owner's personal software application when first installed in the data owner's personal computing device. This provides for a data owner-centric operation.

Specifically, the data owner contributes by giving its name and/or further personal identifiers and the consent and request that its personal data be used for a purpose that is useful to the data owner and to the other computer systems participating in the data exchange. The data provider computer server supplies the personal data that is of interest to the other parties, pursuant to the data owner's request and in line with the citizen's right to data portability, in force in many jurisdictions and notably in the European Union under the GDPR. Examples of such data providers include banks, hospitals, insurance companies and other public and private institutions. The service provider is the data owner's trusted entity that processes the data owner's anonymised personal data in a secure and efficient manner.

Third parties exist that are specialists in data processing and have a scientific, regulatory, or business interest in the personal data managed by the service provider but have no need to access the data owner's name identification. The user identification data body is the entity which stores the data owner's user preferences and requests as well as the means necessary to the identification and reidentification of the data owner, and the means necessary to contact the data owner, but has no other data owner personal data. All of these parties conduct these operations via computers, which communicate and cooperate with each other to process data owner personal data for a useful or valuable purpose, but in a way which conforms to the law and upholds the data owner's right to the protection of personal data and privacy rights.

The present disclosure describes the means for the user identification data computer server to join all data items—the information of interest, the additional information and the data owner's name and other personal identifiers—to successfully reidentify the data owner. In the health data scenario previously described, vital new information will be received in the user identification data computer server, relayed by the service provider computer server, or directly received from the third-party computer where it was created by researchers and other experts by processing the original health data. Once the user identification data computer server has reidentified the anonymised data and its data owner, the user identification data computer server will transmit the new information to the health care professional's computer of the concerned data owner, for appropriate medical action, or to other computer systems where the data owner's anonymous data needs to be associated with the data owner's identity.

In the voting example, voter registration may be periodically verified and compared with place of residence, to clean voting rolls of those voters who have moved, but the reidentification functionality will not be available to see how the voter voted. In the insurance scenario, the reidentification feature will be disabled, to prevent increasing the insurance policy premium of one individual with a given risk profile but enabled if the data is shared with a health care professional or another entity having a lawful and ethical purpose. Thus, depending on the identity and the function of the recipient of the personal data, the present disclosure enables managing a data owner's name and/or further personal identifiers, allowing their data to be anonymised or reidentified as needed.

Cryptography is used in the present disclosure. Public key/private key cryptographic systems used herein may employ the RSA asymmetric key cryptographic technique, as well the Elliptical Curve Digital Signature Algorithm (ECDSA), a variant of RSA. Future asymmetric key systems are also usable in the present disclosure, provided that these asymmetric key systems use a private and a public key that are mathematically related. In use, the data is encrypted by the data owner's personal software application prior to transmission using the data owner's private key k1, which is known to the data owner personal software application only. The computer which receives the encrypted data uses the data owner's public key k2, which is usually publicly known, to decrypt the message. The present method may use a public key k2 that is itself encrypted, so that only computer systems having the decryption key to the encrypted public key k2 may decrypt originator messages encrypted with the private key k1. This may employ a different public/private key pair or use a symmetric key which is used for both encryption and decryption and is shared confidentially between originator and recipient, or additionally employ a hashing function. Encrypting or otherwise manipulating the public key therefore introduces an additional layer of security and helps control which computer system has access to decrypting data, the data owner's name and/or further personal identifiers.

Other important cryptographic methods used herein include cryptographic hashes and digital signatures.

Modern cryptographic hash algorithms, such as SHA-2, SHA-256 and BLAKE2, are considered secure enough for most applications. SHA-2 is a family of strong cryptographic hash functions, based on the Merkle-Damgård cryptographic concept and is considered highly secure. SHA-3 is considered highly secure and is published as official recommended crypto standard in the United States. The Digital Signature Algorithm (DSA) is a Federal Information Processing Standard for digital signatures. Any of these modern secure hash algorithms, or their successors, are useful in the present disclosure. These functions are often part of the standard libraries of modern programming languages and platforms. The input value for this function can be a document, a string, or a cryptographic key, and the output is an alphanumeric expression which is infeasible to invert back to the original input value since hash functions are one-way functions. This is useful to securely store passwords and cryptographic keys. Whenever a computer receives a login request or key the computer needs to verify, the computer calculates its hash value according to the method that has been chosen and compares the calculated hash value with hash value that is stored in its storage medium. If the calculated value and the stored value are the same, then the input value is confirmed, and access is authorised.

Digital signatures are a cryptographic tool to sign digital messages and verify message signatures in order to provide proof of authenticity for the digital messages or electronic documents. The digital signatures provide message authentication, integrity, and non-repudiation, features in the present disclosure, where the receiving computer must verify the identity of the sending computer and the identity, either name or anonymous, of the data owner of the information transmitted. The digital signatures bind the digital messages to the data owner public key or to the transmitting computer public key.

In one example, the digital message to be signed consists of the sender's request to log in into a computer of interest, which on being successfully read will prove its content and its origin. The sending computer will digitally sign the message using the sender's private key k1 and send the signed message to the receiving computer. The receiving computer will read the signature in the message and verifies the user is a known user by using the sending computer's public key k2 known to the receiving computer, as well as the methods described above for asymmetric keys, hash functions and digital signatures. If the content of the signed message is equal to the sending computer's public key, the digital signature has been successfully verified and login access is authorised.

In order to digitally sign longer ones of the digital messages, it is useful to hash the entire message first, encrypt the digital message with the sender's private key, and then transmit the resulting encrypted digital message to the receiving computer for verification. The expert in the field will be able to replicate the above method. which is explained in detail in the websites cryptobook.nakov.com/digital-signatures and https://www.cisa.gov/uscert/ncas/tips/ST04-018.

Additionally, blockchain may be useful to record transactions of information between the computers of the users, user data identification entities, the data providers, other data operators and the third-party entities and may give the data owner the possibility to tailor consent and viewing rights for its personal data via the use of smart contracts, a feature of blockchain. The smart contracts allow the data owner to specify via its computer who and whose computers can see the personal data and the data of interest, which categories of data can be seen and by whom, which can be written and by whom, which actions can be authorised depending on the underlying data of interest, and to globally or selectively grant or remove consent and computer access rights as well as associate monetization rules to each element of personal data.

These methods of computer cryptography—symmetric key, asymmetric keys, hashing, digital signatures and blockchain—may be usefully combined in practical aspects of the present disclosure. Other encryption features such as session keys, key rings, temporary keys, and tokens as well as any other encryption system may be used as well.

In order to make the system even more secure, the system may be supplemented by a secure processing environment where the third-party computers, operated by researchers or experts participating in the further processing of the data owner's personal data, cannot display and have no physical access to the data itself, nor to the data owner's personal code k3, but only to remote access of the former, i.e. personal data or other data of interest. By preventing direct access to the data owner's public key k2, the secure processing environment of the present disclosure prevents the factorization of the public key k2 to extract the private key k1, which would be technically possible using quantum computers currently in development.

Thus, personal data is not visible to the researcher, but only its metadata—data describing the personal data, such as numbers of data owners, classified by attributes which are of interest to the researcher. Examples of such metadata include statistical data and numbers of data owners per sex, per year of birth, per postal code, per occupation or per type of goods purchased.

In a health care scenario, examples of metadata include the number of patients in each specific category of diagnoses, treatments, prescriptions, clinical test results and medical outcomes. In this secure processing environment, the researcher does not have visual access to the data, which if subsequently interconnected with other data sources, could reveal the identity of the data owner. For instance, a blood test contains 10 to 20 alphanumeric results and a date. The data owner's name could be found by subsequently cross-referencing this dataset with data from a clinical testing services operator's database, to which the researcher might have access. In the secure processing environment of this application, it is impossible to find the data owner's name by subsequently cross-referencing datasets, without resorting to the method and system herein described.

To illustrate how the researcher would then be able to work in the further processing of personal data, the computer used in this secure processing environment allows searching based on selection criteria—say search all diabetics aged 50 to 60, with high blood pressure and a body mass index greater than 30—and then runs a program that calculates correlations between these health and illness indicators and the drugs that were prescribed to those same patients. This allows computer processing to reveal which drugs were most effective as well as which caused a higher rate of side effects. This is an information result of the utmost importance that must be communicated to each patient and their health professional, for confirmation or modification of the therapeutic plan. The identification, deidentification, and reidentification method described in this disclosure, when combined with a secure processing environment, reduces the reidentification risk by unauthorised persons or computers substantially to zero.

In a further aspect of the invention enhancing data security, the number of keys composing the Global Confidential Identifier can be increased from three to four, or even more, so that each receiving computer has a different form of the data owner's public key k2 and personal code k3. In this case, there must be a computer table where each registered user entry contains all different forms of the public key k2 and personal code k3 used for that data owner, and this table may be stored in the service provider computer server. Alternatively, the table may be divided in two parts, one part being stored in the service provider computer server, and another in the user identification data computer server. However, one private key k1, one public key k2 and one personal code k3 are sufficient for the present method and system to work as per the present disclosure.

The present disclosure describes a fully integrated personal data protection system operated by computers and data protection methods which start with the data owner's personal computing device and links the participating computers in an unbroken thread, where the data processing is enabled and governed by the personal computing device.

The system and method described comprises the data owner or the data subject the data owner's personal computing device running the personal software application, the user identification data computer server, the data provider computer server, the service provider computer server, and the third-party computer. All of these computing devices and servers run application programmes, data exchange programmes, encryption and decryption programmes and store data in files and databases. The use of these computing devices and servers configured to run the software described allow the system and method of the present disclosure to operate and to provide the solution to the technical problems that have been identified with respect to the protection of personal data and privacy rights, based on revealing a person's name and identity, hiding them, and revealing them again within the computers of the present system.

The personal computing device of the data owner can be, for example, a personal computer, a smartphone, or a tablet, but the smartphone is preferred, on account of being a very personal device. The smartphone or other personal computing device may be configured to perform the steps described herein by means of a personal software application downloaded into the personal computing device from a website or from an app distribution service such as Appstore or Google Play. The purpose of this personal software application is to enable the user and data owner to manage personal data and to enable the process whereby user data is identified, deidentified and reidentified.

The computer server systems described herein include the computer servers operated by the data providers, the user identification data entity, the third-parties engaged in further processing and by other data operators and these servers will generally be systems with considerable computing power, storage, and communications capabilities. The data is exchanged between the personal computing device, the user identification data computer server, the data provider computer server, the service provider computer server, and the third-party computers by means of appropriate data communications software stored in each one of them.

All of the computer systems in the present invention comprise a processor, a memory capable of storing programme instructions, communications subsystems, storage media, input devices such as a keyboard, mouse, pointer, tactile screen, microphone or camera, and output devices such as a display screen and a loudspeaker. The computer systems are able to communicate with each other using private or public telecommunications networks, but the public network is preferred, and the preferred medium is the internet. They can also take place in a private network or in a virtual private network. All communications between the various parties are desirably encrypted using standard internet protocols, such as HTTP+TLS/SSL and IPsec or any successor protocol of equal or greater security.

The data owner is represented by a personal code k3 which is the data owner's identification in situations where names or conventional personal identifiers have been removed from the data records of interest. The personal code is sufficiently large to uniquely identify every member of a target population. In addition to key k3, the data owner may also be represented and uniquely identified by public key k2, but k2 will only be known to the data owner's personal software application and to the service provider computer server. Keys k2 and k3 are unique codes, each uniquely representing the data owner. Using these two components of the Global Confidential Identifier each to be used depending on the identity and function of the recipient of the data, to designate the same data owner, increases the complexity of the protection measures and the level of security.

In one aspect, the data owner or user downloads the personal software application into the personal computing device, which can be a smartphone, a tablet, a laptop computer, or a desktop computer. The installation of the personal software application by the data owner comprises defining a locally stored PIN or password and entering the name and/or the further personal identifiers, user preferences, authorisations and requests that are specific to the practical purpose of the personal software application. As the personal software application is installed, the personal software application may include a step to confirm the data owner's identity, and this confirmation can be achieved using government supplied authentication means, face-to-face confirmation at a registration desk, biometric means, connecting to a trusted data base of verified identities or any other acceptable confirmation method. This confirmation step is desirable, as this confirmation step creates certainty around the user's identity, which is essential in activities such as health care and voting.

The personal software application also generates cryptographic keys, namely a pair of asymmetric public k2 and private k1 keys, as well as the data owner's personal code k3.

During the installation of the personal software application, two contacts are executed by the personal computing device. A first contact is to the user data identification computer server, and a second contact is to the service provider computer server.

In the first contact to the user data identification computer server, the personal software application sends the data owner's name and/or further personal identifiers, user preferences, authorisations, and requests, as well as the personal code k3. The user identification data computer server receives, stores, and then transmits this data to the data provider computer server, of which there can be one or more.

The data provider computer server receives the data, including the data owner's name, personal identifiers, a request to have the personal data copied to a designated service provider computer server, and the personal code k3. The data provider computer server searches its application database for the data pertaining to this data owner and on finding the data, obtains the data and replaces the data owner's name and all further personal identifiers by personal code k3 and transmits the thus anonymised and deidentified data to the service provider computer server, an action which will be repeated periodically whenever new data of interest is stored in the application database of the data provider computer server.

In the second contact, which is nearly simultaneous with the first contact, the personal software application sends a message to the service provider computer server, to indicate that a new anonymous data owner has been created and transmits keys k2 and k3 as well as preferences, authorisations, and requests, but no name or other personal identifiers of any kind. The installation of the personal software application is concluded.

When the data owner uses the newly installed application for the first time, there is a need to link the data owner's personal computing device to the personal software application running therein to the service provider's computer server. The data owner keys in the personal PIN to open the personal software application, which then sends a digitally signed message to the service provider computer server. This procedure will prove to the service provider computer server that the message is being sent by the data owner that was previously registered during the second contact described above. The digitally signed message may include a timestamp, so that the receiving party may process only very recent messages. The digitally signed message is comprised of, at least, the personal code k3 in plaintext, and the public key k2 encrypted by private key k1. The service provider computer server reads the personal code k3, uses it to retrieve the data owner's registration data in its user registration data base, from which it reads the data owner's stored key k2. Using this key k2, the service provider computer attempts to decrypt the encrypted part of the digitally signed message. If the decryption returns the data owner's public key k2 identical to the key k2 stored in the user registration data base, then the message is considered valid and the data owner is authenticated.

Successfully reading the digital signature proves the digital signature was signed by the private key k1 associated with the public key k2 of the user. This allows the service provider computer server to confirm that the personal computing device used to install the personal software application of the data owner whose identity was desirably confirmed, is the same device now being used by that same data owner, who has entered the same PIN that was previously defined. The service provider computer server now stores keys k2 and k3, as anonymous and confidential identifiers of the same data owner. Besides the data owner's personal computing device, the service provider computer server is the only computer server in the present disclosure to have access to both the public key k2 and the personal code k3.

All subsequent communications sessions between the personal software application and the service provider computer server are always initiated by the data owner using the personal computing device and logging into the personal software application, causing the personal software application to send a digitally signed message identical or substantially similar to the digitally signed message generated during the first communications session with the service provider computer server. The service provider computer server successfully reads the message and determines the data owner is a known, valid data owner and enables data communications between the service provider computer server and the personal software application, uploading or downloading data of interest to or from the personal software application. The service provider computer server is thus able to conduct secure communications with a data owner whose identity is unknown but is the data owner of the personal data.

Subsequently, the service provider computer server may enable data communications between its application database and the third-party computer for further processing of the data owner's data periodically obtained from the data providers' computer servers. Access will be provided to the personal data of interest, where each of the data records are now exclusively identified by personal code k3. The third-party computer is only able to access the deidentified data.

Should there be a need to reidentify the data owner to convey new or important information, such as but not limited to vital information in the health context, or for any other reason, the third-party's computer sends that new information to the service provider computer server, as well as the personal code k3 of the data owner concerned by that new information. The service provider computer server receives the information and the personal code k3 sends the information and personal code k3 to the user identification data computer server.

The user identification data computer server receives the message and using personal code k3 stored in its user registration database, reads the data owner's name and/or further personal identifiers associated with the data owner as well as any contact details for this data owner. The user identification data computer server uses these contact details to forward to the data owner or to other persons who have a need to know, the new important or useful information that was generated by the third-party's computer using anonymised data, but this time reidentified with the data owner's name and/or further personal identifiers.

Apart from the data owner's personal software application, the only entity that has access to the data owner's public key k2 and personal code k3 is the service provider computer server which plays an important role in reverting the anonymisation of the deidentified data, without ever knowing the data owners' names and/or the further personal identifiers. Moreover, only the service provider computer server is able to confirm that the data owner's personal code was created in the same personal computing device subsequently used for the practical purposes of the personal software application. If the desirable step of user identity confirmation is included in the personal software application installation process, or performed afterwards, then the service provider computer server can also provide for the deidentified personal data to be traced back to its legal owner, without any risk of misidentification and without ever knowing the data owner's name. It is through the collaboration of the service provider computer server and the user identification data computer server that data owners may be securely identified, deidentified and reidentified, through the cryptographic keys and different keys of the Global Confidential Identifier generated by the data owner's personal computing device and selectively transmitted to the computer systems of the present disclosure.

### DESCRIPTION OF THE FIGURES

FIG. 1A shows a block diagram of a system architecture used to download and install a personal software application into a personal computing device, according to an example aspect of the present disclosure.

FIG. 1B shows a block diagram of a computer system architecture used to connect the personal computing device, a user identification data computer server, a data provider computer server, a service provider computer server, and a third-party computer to establish communications between all of them, according to an example aspect of the present disclosure.

FIG. 1C shows a flow chart describing a computer-implemented method for re-associating anonymised data with a data owner, according to an example aspect of the present disclosure.

FIG. 2A shows a data flow diagram describing the installation of the personal software application in the personal computing device, according to an example aspect of the present disclosure.

FIG. 2B shows a data flow diagram between the personal computing device and the service provider computer server for receiving updates in the personal software application, according to an example aspect of the present disclosure.

FIG. 2C shows a data flow diagram describing the transmission of the deidentified personal data to the third-party computer and its reidentification by the service provider computer server and the user identification data computer server, according to an example aspect of the present disclosure.

FIG. 3 shows a block diagram of the personal computing device, according to an example aspect of the present disclosure.

FIG. 4 shows a block diagram of the user identification data computer server, according to an example aspect of the present disclosure.

FIG. 5 shows a block diagram of the data provider computer server, according to an example aspect of the present disclosure.

FIG. 6 shows a block diagram of the service provider computer server, according to an example aspect of the present disclosure.

FIG. 7 shows a block diagram of the third-party computer server, according to an example aspect of the present disclosure.

### DETAILED DESCRIPTION OF THE INVENTION

The invention will now be described on the basis of the figures. It will be understood that the aspects and aspects of the invention described herein are only examples and do not limit the protective scope of the claims in any way. The invention is defined by the claims and their equivalents. It will be understood that features of one aspect or aspects of the invention can be combined with a feature of a different aspect or aspects and/or aspects of the invention.

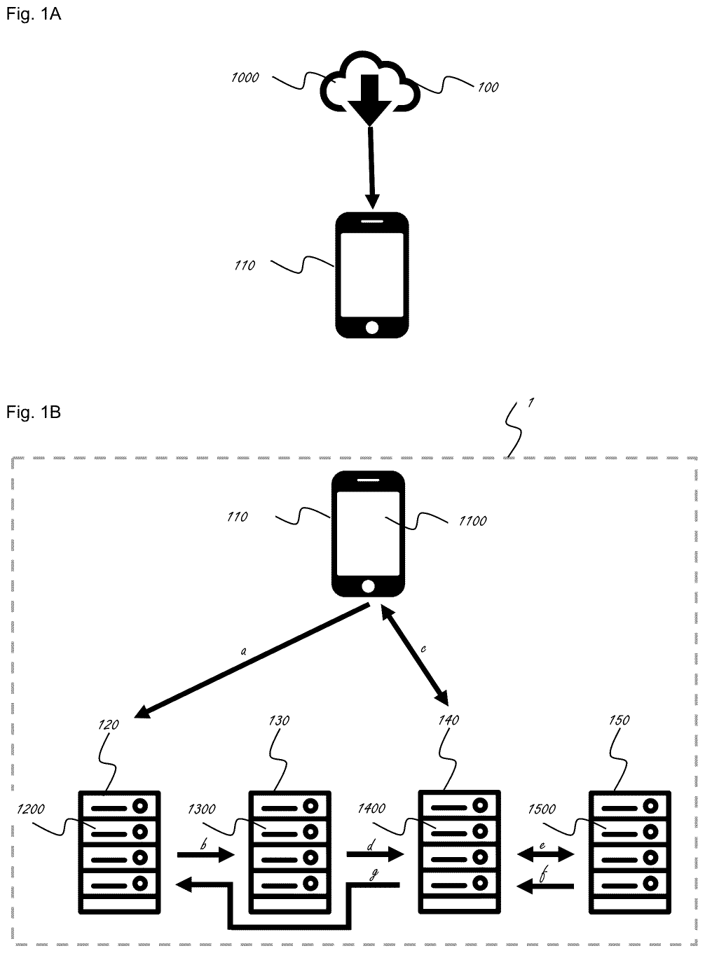

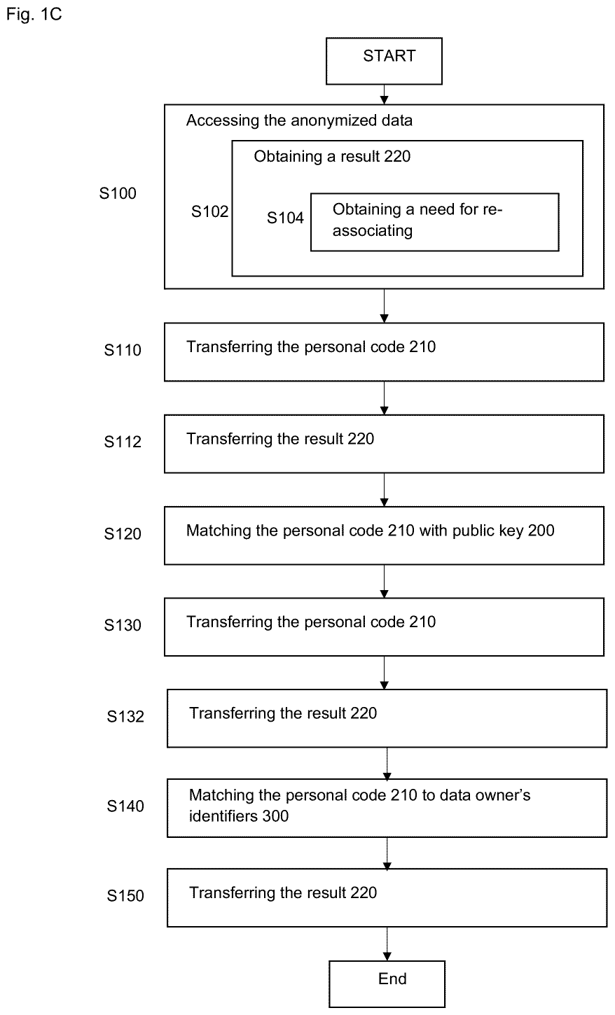

In FIG. 1A, a data owner 10 or data subject or user, patient, or person connects its personal computing device 110 to a communication network. The communication network can be a public mobile digital communications network, for example the Global System for Mobile Communications (GSM), or the internet. Then the data owner 10 downloads a software application 1000 which comprises the programmes needed for the operation of the method and system of the present disclosure. The software application 1000 is downloaded from an appropriate software distribution system 100, such as AppStore or Google Play, or an internet web site, to which the data owner 10 connects using the personal computing device 110.

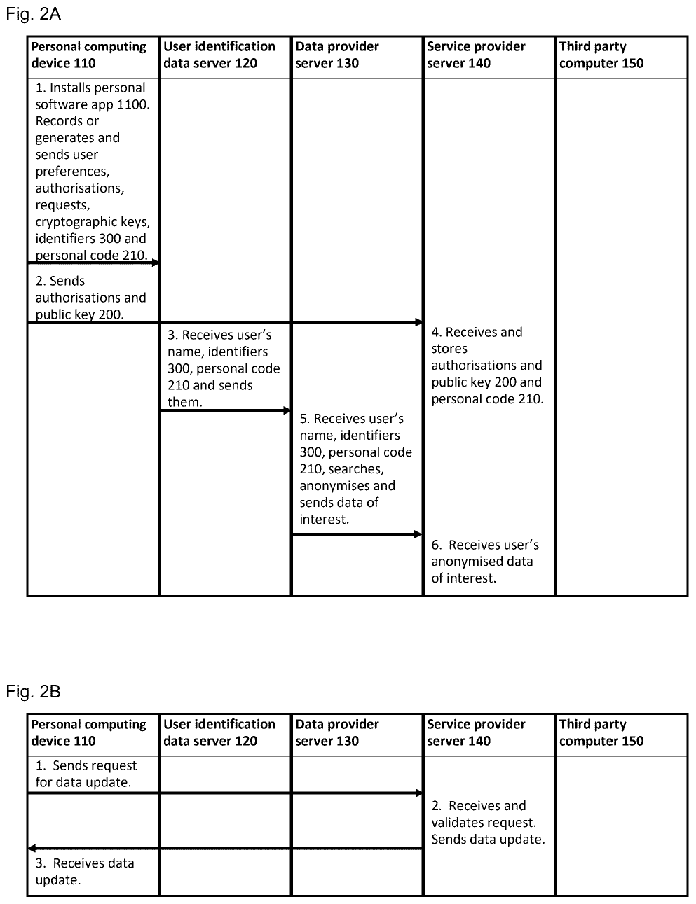

The detailed explanation of FIG. 1B is now complemented by references to the data flow diagrams in FIGS. 2A, 2B and 2C.

In FIG. 1B, the software application 1000 is installed as a personal software application 1100 of the data owner 10, comprising identifiers 300 such as the data owner's 10 name and/or further personal identifiers, preferences, authorisations, and requests entered or made available by the data owner 10. The personal software application 1100 records a data owner 10 defined PIN or password and generates a pair of asymmetric cryptographic keys, namely a private key 190, a public key 200 and a personal code 210. This corresponds to step 1 in FIG. 2A.

The personal software application 1100 of the personal computing device 110 sends (arrow a) a data message, including the identifiers 300 of the data owner 10, such as the name and/or the further personal identifiers 300, preferences, authorisations, requests, and the personal code 210, but not the PIN, private key 190 or public key 200, to a user identification data computer server 120. This corresponds to step 1 in FIG. 2A.

A software application 1200 contained in the user identification data computer server 120 receives, stores, and processes the data message from the personal software application 1100, and sends the data message (arrow b) to a data provider computer server 130. This corresponds to step 3 in FIG. 2A.

The personal software application 1100 of the personal computing device 110 also sends the data message (arrow c)—including preferences, authorisations, requests, the public key 200 which has been digitally signed using the private key 190, the plaintext personal code 210, but not the data owner's 10 name, personal identifiers 300, PIN or private key 190—to a service provider computer server 140. This corresponds to step 2 in FIG. 2A.

The service provider computer server 140 receives and stores the data received from the data provider computer server 130. This corresponds to step 4 in FIG. 2A.

Software applications 1300 contained in the data provider computer servers 130 receive, store, and process the data message received from the software applications 1200 in the user identification data computer server 120. Acting on the data owner's 10 preferences, authorisations and requests received, and using the name and/or the further personal identifiers 300, the data provider computer server 130 searches that data owner's 10 personal data of interest, and on finding the personal data, removes name and further personal identifiers 300 from the personal data, and replaces the names and further personal identifiers 300 with the data owner's personal code 210. In order to increase the interoperability, usefulness and validity of the transmitted data, the parties operating the data provider computer server 130 and the service provider computer server 140 may agree on data standards, coding standards, communications protocols and database formats, so that when the personal data is received by the service provider computer server 140, the personal data is already of a high quality, confidentially identified and highly suitable for further processing. Then the data provider computer server 130 sends (arrow d) the deidentified, structured, and curated personal data of interest and the data owner's 10 personal code 210 to the service provider computer server 140. This corresponds to step 5 in FIG. 2A.

The transmission of the deidentified, structured, and curated data of interest and the data owner's 10 personal code 210 to the service provider computer server 140 occurs periodically, for as long as the data owner's 10 request for data transmission remains valid and in force and whenever new personal data of interest is stored at the data provider computer server 130. For instance, this is the case when a patient visits a doctor and a new diagnosis is established, or a voter changes residence.

Software applications 1400 contained in the service provider computer servers 140 receive and process the data message from the software applications 1300 in the user identification data computer server 120 and store the data message as deidentified data, exclusively identified by public key 200 and by personal code 210. Since the service provider computer server 140 has access to both public key 200 and personal code 210 it does not matter which one of the two forms the service provider computer server uses internally. This corresponds to step 6 in FIG. 2A.

For the periodic update of data of interest in the personal software application 1100 during routine operation, when the data owner 10 opens the personal software application 1100, the personal software application 1100 contacts the service provider computer server 140 by sending (arrow c) the data owner's 10 personal code 200, digitally signed using the data owner's 10 private key 190, as well as personal code 210. This corresponds to step 1 of FIG. 2B.

On receiving the data owner's 10 personal code 210, the service provider computer server 140 reads the digital signature and if this reading is successful, confirms the data owner's 10 public key 200 and personal code 210 as a valid request of a previously registered data owner 10. The service provider computer server 140 uploads (arrow c) to the personal software application 1100 new data of interest stored in its database, received since the last data update from the data provider computer server 130. This corresponds to step 2 of FIG. 2B.

The personal software application 1100 in the personal computing device 110 receives and stores the updated data of interest. This corresponds to step 3 of FIG. 2B.

Thus, the data owner's 10 personal software application 1100 regularly receives up-to-date information or data of interest, which had originated at the data provider computer server 130. An advantage is that information pertaining to the same data owner 10, stored at multiple data provider computer servers 130 may be uploaded to the personal computing device 110, where the information is stored in a structured and well-organized way in the personal software application 1100. Applications that particularly benefit from multi-source data combination are electronic health record applications, where the user or data owner 10 may have their complete health history, originating from different hospitals, easily accessible at its personal computing device 110, and from which the data owner 10 can easily share the clinical data with designated health care professionals.

A further advantage is that the service provider computer server 140, even though the service provider computer server 140 does not know the data owner's 10 identifiers 300 such as name and/or further personal identifiers, is certain that the data owner 10 and the owner of the personal computing device 110 are the same person. The data of interest is always transmitted to its owner, and mistaken identities are technically impossible in the uploading of personal data by the service provider computer server 140 to the data owner's 10 personal computing device 110.

Still in FIG. 1B, the third-party researcher or a data expert or data scientist has an interest in the personal data contained in the service provider computer server 140 and uses the third-party computer 150, comprising software applications 1500, to connect (arrow e) to the service provider computer server 140 and request access to the deidentified data for further processing. This corresponds to step 1 of FIG. 2C.

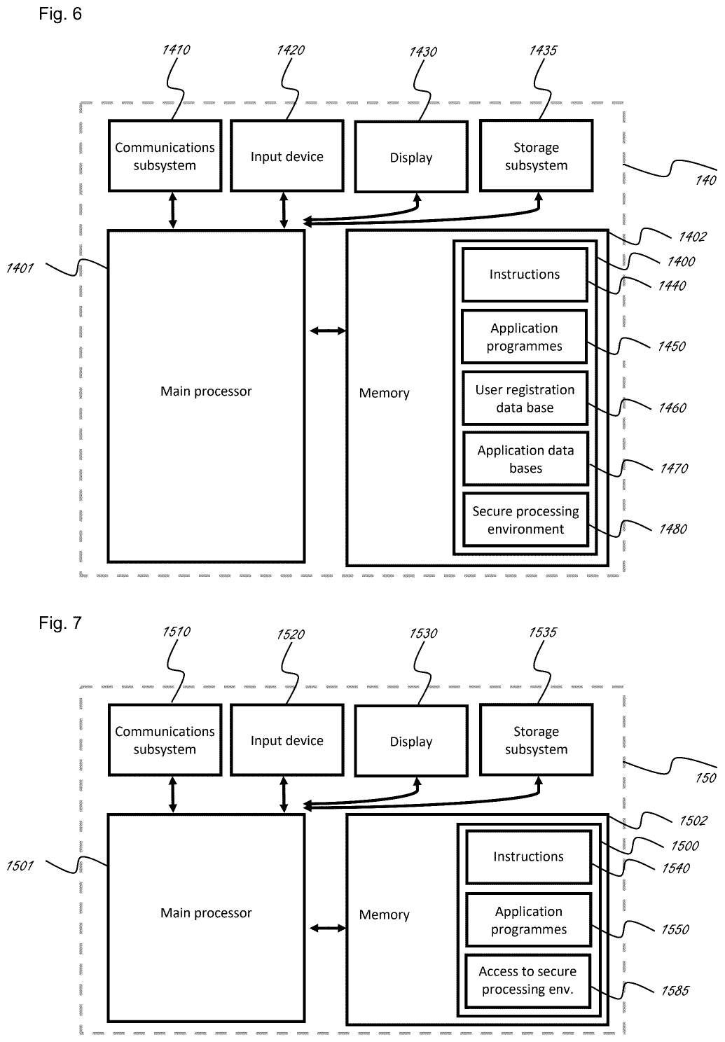

Since the data base containing personal data accumulated over time at the service provider computer server 140 is of a substantial size, the data base holds value for the data scientist and may be processed using state of the art techniques such as Big Data, machine learning and artificial intelligence as well as conventional statistics or used for algorithm development. Thus, the third-party computer 150 connects to the service provider computer server 140 and preferably to a secure processing environment that is included in the software applications 1400 and is illustrated in FIG. 6 with numeral 1480. In certain embodiments, the secure processing environment 1480 may be a standalone computer server, distinct from the service provider computer server 140.

The secure processing environment 1480 of the service provider computer server 140 allows only authorised data scientists to access the service provider computer server 140. The deidentified data of interest will not be stored in the third-party's computer 150, nor will the deidentified data be downloaded to the third-party's computer 150. The deidentified data remains always in the service provider computer server 140 and is processed by the third-party's computer 150 sending commands (arrow e) which trigger data processing operations in the service provider computer server 140. Thus, the data scientist operating the third-party computer 150 is granted access to the personal data, not to its physical possession and the secure processing environment 1480 enables the third-party computer 150 to read data records identified only by the data owner's personal code 210. This corresponds to step 2 in FIG. 2C.

The data scientist does not have visual access to the data of interest, so that there is no possibility to match any of the elements of the data of interest with other data bases which could have data elements related to the same person and create conditions for uncontrolled user reidentification. Instead, the data scientist specifies a data strategy, by defining search criteria to obtain a target population, and study criteria to obtain a desired result. The former will include data science programmes and algorithms, desirably included in the secure processing environment 1480, so that source data and operating computer programmes that process them are part of the same computer space. This further data processing may produce information or a result 220 such as a useful information that needs to be re-associated with its data owner 10, or, on occasions, even yield new discoveries that are vitally important to the data owner 10. This corresponds to step 3 of FIG. 2C.

On finding a need to associate a result 220 or data element or new information or new vital or useful information to its data owner 10, the data scientist's third-party computer 150 only has the data owner's 10 personal code 210 to identify the concerned data owner 10. The third-party computer 150 sends (arrow f) the result 220 with the new information and the concerned data owner's 10 personal code 210 to the service provider computer server 140. This corresponds to step 4 of FIG. 2c.

The service provider computer server 140 receives the new information or result 220 and the data owner's 10 personal code 210, searches its user registration data base to verify that personal code 210 corresponds to a known data owner 10, and also collects more personal information that was not included in the original data scientist's search parameters, but which may be useful and provide better context. In the health care scenario, this can be adding the full clinical history to the new information of interest or result 220 to be sent to the concerned but still deidentified patient or data owner 10 and attending health care professionals. The full data message is sent (arrow g) by the service provider computer server 140 to the user identification data computer server 120. This corresponds to step 5 of FIG. 2C.

The user identification data computer server 120 receives the data message from the service provider computer server 140, comprising the information of interest or result 220 for a specific user or group of data owners 10 and their personal codes 210. Since the user identification data computer server 120 had recorded earlier the data owner's 10 identifiers 300 such as name, personal identifiers and the personal code 210 (step 3 of FIG. 2A), the user identification data computer server 120 is able to look up the data owner's 10 personal code 210 in its user database and identify the data owner's 10 identifiers 300 such as name, further personal identifiers and contact details. This corresponds to step 6 of FIG. 2C.

The user identification data computer server 120 is now able to send the new information or result 220 associated to the concerned data owner 10 and now identified by its name and identifiers 300, to the computers of all authorised parties who have a need to know the new information or result 220, such as the data owner 10, or a patient's health care professional, or even to the data scientist if there is a valid and legal motive. Ideally, the reidentification data must never be sent to the service provider computer server 140, so that its anonymised data always remains so, and the service provider computer server 140 is technically unable to revert the deidentification of data owners and the data controller operating it can claim to be the trusted home for the safekeeping of people's personal data.

The following table illustrates which computer systems have access to which user identifiers 300, cryptographic keys 190, 200 and personal code 210, where 1 indicates access, and 0 indicates no access.

| | | User | | | |
|---|---|---|---|---|---|
| | | identi- | | | |
| | | fication | Data | Service | |
| | Personal | data | provider | provider | Third- |
| | computing | computer | computer | computer | party |
| | device | server | server | server | computer |
| | 110 | 120 | 130 | 140 | 150 |
| Name + | 1 | 1 | 1 | 0 | 0 |
| identifiers | | | | | |
| 300 | | | | | |
| Private key | 1 | 0 | 0 | 0 | 0 |
| 190 | | | | | |
| Public key | 1 | 0 | 0 | 1 | 0 |
| 200 | | | | | |
| Personal | 1 | 1 | 1 | 1 | 1 |
| code 210 | | | | | |

The table indicates that access to the data owner's 10 identifiers 300 such as the name and/or further personal identifiers only happens for those computer systems that are personal devices or are intended to manage identifiable data. The most widely known confidential identifier is personal code 210 Since the third-party computer 150 is the first to discover the result 220, which may contain sensitive or confidential information for data owner 10, specific security measures should be provided. The third-party computer 150, when processing data in the secure processing environment 1480 via the access interface 1585 to the secure processing environment 1480, does not have direct, physical access to the data owner's 10 public key 200 or personal code 210. It is the service provider computer server 140 operating the secure processing environment 1480 which, in collaboration with the user data identification computer server 120, will match and re-associate the personal code 210 to the name and identifiers 300 of the data owner 10.

To reidentify the data owner 10, three computer systems in the present disclosure must cooperate: the third-party computer 150 derives the information or result 220 that needs to be associated with the concerned data owner 10 name and identifiers 300, the service provider computer server 140 verifies that the data owner 10 whose personal data has been processed to obtain a result 220 is a validly registered user and links the result 220 and any other useful information for transmission to the user identification data computer server 120. The user identification data computer server 120 uses the personal code 210 to retrieve the data owner's 10 identifiers 300 such as the name and/or further personal identifiers and/or contact details.

FIG. 1C shows a flow chart describing a computer-implemented method for re-associating anonymised data with a data owner 10. The anonymised data stored on the service provider computer server 140 is accessed in a step S100 by the third-party computer 150. The step of accessing the anonymised data S100 comprises processing the anonymised data S100 and obtaining the result 220 derived from accessing and/or processing the anonymised data in step S100. The step S102 comprises in a step S104 the need to associate the anonymised data, used to create the result 220, with the data owner 10.

The personal code 210 is transferred in a step S110 from the third-party computer 150 to the service provider computer server 140. The result 220 is transferred in a step S112 together with the personal code 210 from the third-party computer 150 to the service provider computer server 140. The personal code 210 is matched in a step S120 with the public key 200 at the service provider computer server 140 and the personal code 210 is transferred in a step S130 from the service provider computer server 140 to the user identification data computer server 120.

The result 220 is transferred in a step S132 together with the personal code 210 from the service provider computer server 140 to the user identification data computer server 120. The personal code 210 is matched in a step S140 to the data owner identifiers 300 by the user identification data computer server 120. The result 220 is transferred in a step S150 to the personal computing device 110 of the data owner 10 and to the computer of the attending health care professional of data owner 10.

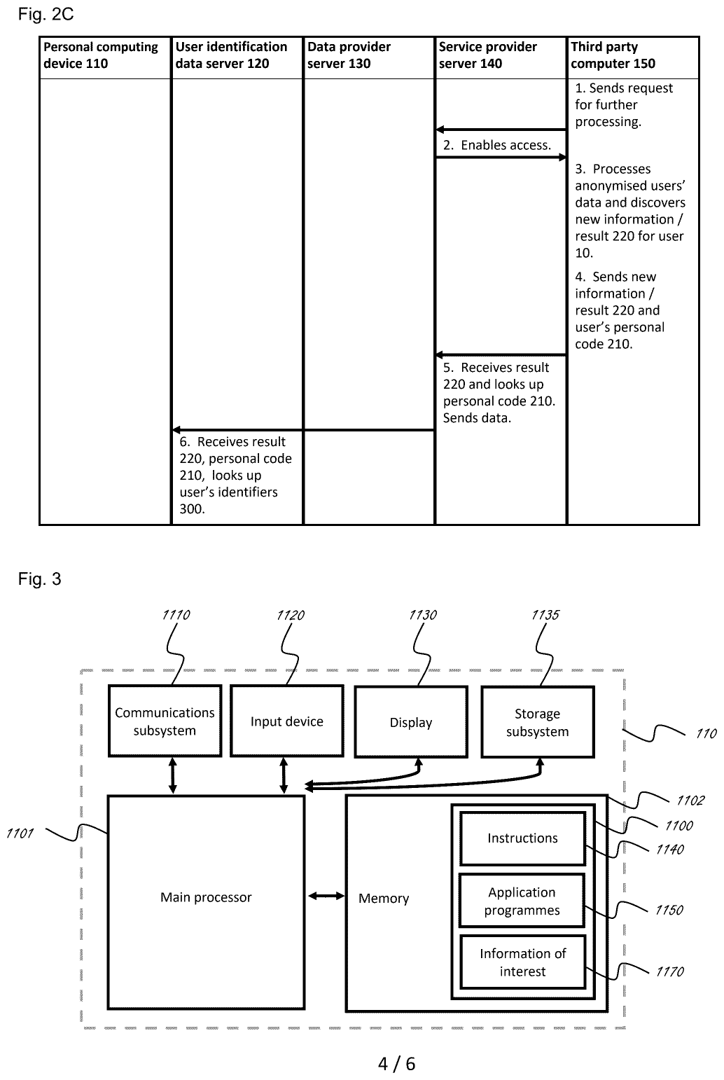

FIG. 3 illustrates the hardware and software components of the personal computing device 110. The personal computing device 110 comprises a main processor 1101, a communications subsystem 1110 designed to communicate over the communications network with participating computer systems, as illustrated in FIGS. 1B and 2A, 2B and 2C, an input device 1120, a display 1130, and a storage media subsystem 1135 storing computer programmes and data. The processor 1101 interacts with the memory 1102 containing the personal software application 1100 and data retrieved from the media storage subsystem 1135. The processor 1101 loads into the memory 1102, as needed, programme instructions 1140, the applications programmes 1150, and data from files storing the information of interest 1170 received from the service provider computer server 140.

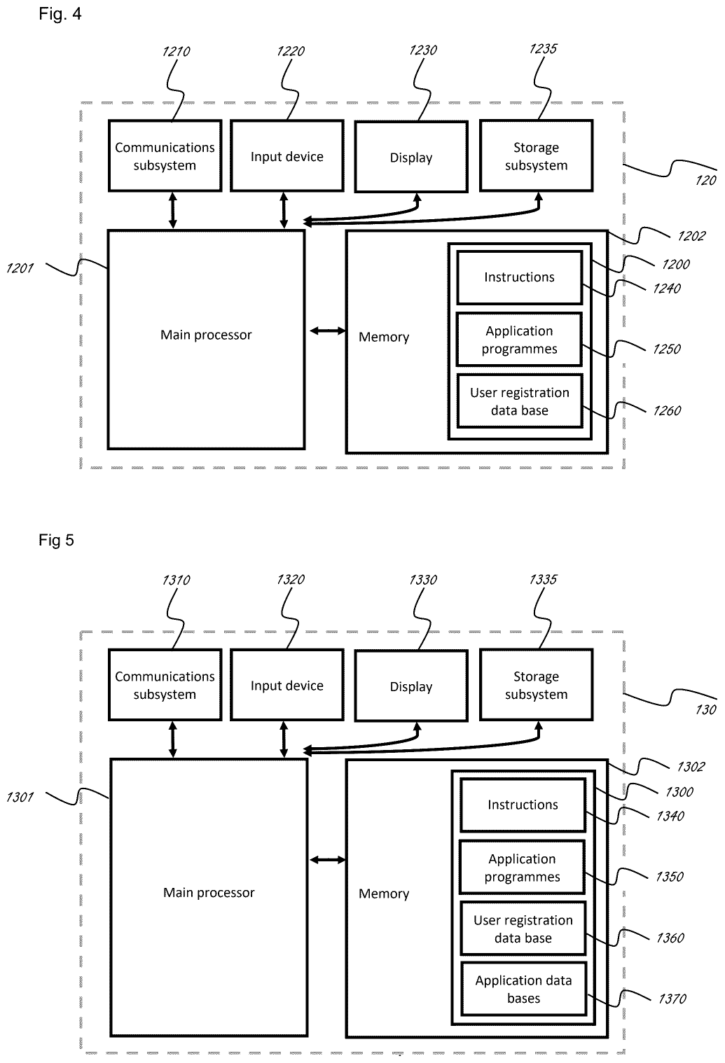

FIG. 4 illustrates the hardware and software components of the one or more user identification data computer servers 120. The one or more user identification data computer servers 120 comprise a main processor 1201, a communications subsystem 1210 designed to communicate over the communications network with participating computer systems as illustrated in FIGS. 1B and 2A, 2B and 2C, an input device 1220, a display 1230 and a storage media subsystem 1235 storing computer programmes and data. The processor 1201 interacts with the memory 1202 containing all software programmes 1200 and data retrieved from the media storage subsystem 1235. The processor 1201 loads into the memory 1202, as needed, programme instructions 1240, the application programmes 1250 and the user registration database 1260.

FIG. 5 illustrates the hardware and software components of the data provider computer server 130. The data provider computer server 130 comprises a main processor 1301, a communications subsystem 1310 designed to communicate over the communications network with participating computer systems as illustrated in FIGS. 1B and 2A, 2B and 2C, input device 1320, a display 1330 and storage media subsystem 1335 storing computer programmes and data. The processor 1301 interacts with the memory 1302 containing software programmes 1300 and data retrieved from the media storage subsystem 1335. The processor 1301 loads into the memory 1302, as needed, programme instructions 1340, application programmes 1350, the user registration database 1360 and the application databases 1370 containing the information of interest of the data owner 10. In use, the programme instructions 1340 will search the user registration database 1360 using the identifiers 300, such as name and/or further personal identifiers of the data owner 10, and on finding the data owner identifiers 300, search that data owner's 10 data of interest in the application database 1370. Then the programme instructions 1340 will replace the data owner's 10 identifiers 300, such as name and/or further personal identifiers, by the data owner's 10 personal code 210, prior to sending the information of interest to the service provider computer server 140.

FIG. 6 illustrates the hardware and software components of the service provider computer server 140. The service provider computer server 140 comprises a main processor 1401, a communications subsystem 1410 designed to communicate over the communications network with participating computer systems as illustrated in FIGS. 1B and 2A, 2B and 2C, an input device 1420, a display 1430 and storage media subsystem 1435 storing computer programmes and data. The processor 1401 interacts with the memory 1402 containing computer programmes 1400 and data retrieved from the media storage subsystem 1435. The processor 1401 loads into the memory 1402, as needed, programme instructions 1440, the application programmes 1450, the user registration database 1460 and the application database 1470 containing the data of interest of the data owner 10. In use, programme instructions 1440 will receive from the data provider computer server 130 data of interest pertaining to the data owner 10, identified solely by the data owner's 10 personal code 210 and will store them in the application database 1470.

Programme instructions 1440 will also periodically upload information of interest to the data owner's 10 personal software application 1100 and give access to the third-party computers 150 for further processing of the data of interest contained in the application databases 1490 of the service provider computer server 140. The programme instructions 1440 will also grant access the third-party computers 150 to the secure processing environment 1480 running in memory 1402, receive from the third-party computers 150 the result 220 containing new information of interest for concerned data owners 10 identified by their personal code 210, and communicate the data of interest 200 and the data owner's 10 personal code 210 to the user identification data computer server 120 for reidentification.

FIG. 7 illustrates the hardware and software components of the third-party computer 150 used in the further processing of personal data stored in the service provider computer server 140. The third-party computer server 150 comprises a main processor 1501, a communications subsystem 1510 designed to communicate over the communications network with participating computer systems as illustrated in FIGS. 1B and 2A, 2B and 2C, an input device 1520, a display 1530 and a storage media subsystem 1535 storing computer programmes and data. The processor 1501 interacts with the memory 1502 containing computer programmes 1500 and data retrieved from the media storage subsystem 1535. The processor 1501 loads into the memory 1502, as needed, programme instructions 1540, as well as a software module that provides an access interface 1585 to the secure processing environment 1480 of the service provider computer server 140. When the third-party computer 150 creates a result 220 with information of interest for one or more data owners 10 who are associated with the original data of interest, the third-party computer 150 transmits the result 220 with information of interest via the secure processing environment 1480 to the service provider computer server 140, together with the data owner's 10 personal code 210.

Although particular aspects of the system and method of the present invention have been illustrated in the accompanying drawings and described in the foregoing detailed description, it will be understood that the invention is not limited to the aspects disclosed, namely in the use of more or less cryptographic means and multiple combinations thereof, but is capable of numerous rearrangements, modifications, and substitutions without departing from the spirit of the invention.

### REFERENCE NUMERALS

1 system
10 data owner
100 software distribution system
110 personal computing device
120 user identification data computer server
130 data provider computer server
140 service provider computer server
150 third-party computer
190 data owner private key
200 data owner public key
210 data owner personal code
220 result
300 data owner identifiers and contact details
1000 software application
1100 personal software application
1101 main processor/processor
1102 memory
1110 communications subsystem
1120 input device
1130 display
1135 media storage subsystem
1140 program instructions
1150 applications programs
1170 information of interest
1200 software applications
1260 user registration data base
1300 software application/programs
1400 software applications
1480 secure processing environment
1500 software applications/computer program
1585 access interface to secure processing environment
S100 accessing the anonymised data
S102 obtaining a need for re-associating
S104 obtaining a result
S110 transferring the first form of the personal code
S112 transferring the result
S120 matching the first form of the personal code
S130 transferring the second form of the personal code
S132 transferring the result
S140 matching the second form of the personal code
S150 transferring the result

1-14. (canceled)

15. A computer-implemented method for re-associating anonymised data with a data owner, wherein the data owner has an associated public key and a personal code, the method comprising:
accessing by a third-party computer the anonymised data stored on a service provider computer server;
transferring the personal code from the third-party computer to the service provider computer server;
matching the personal code with the public key at the service provider computer server;
transferring the personal code from the service provider computer server to a user identification data computer server; and
matching the personal code to a data owner identifier by the user identification data computer server.

16. The computer-implemented method according to claim 15, wherein the data owner identifier is at least one of a name or further personal identifiers of the data owner.

17. The computer-implemented method according to claims 15, wherein the accessing the anonymised data comprises obtaining a need to associate the anonymised data with the data owner.

18. The computer-implemented method according to claim 17, wherein the obtaining a need to associate the anonymised data comprises obtaining a result derived from accessing and processing the anonymised data by the third-party computer.

19. The computer-implemented method according to claim 18, further comprising:
transferring the result together with the personal code from the third-party computer to the service provider computer server; and
transferring the result together with the personal code from the service provider computer server to the user identification data computer server.

20. The computer-implemented method according to claim 19, further comprising transferring the result to a personal computing device of the data owner and to the computer of any authorised entity with the need to know the result.

21. The computer-implemented method of claim 15, wherein the public key is a public asymmetric cryptographic key of the data owner, and the personal code is one of a hashed function of the public key of the data owner or a random number recorded in a computer file as being associated with the public key.

22. The computer-implemented method of claim 20, wherein the public key is known exclusively to the service provider computer server, and to the personal computing device of the data owner.

23. A system for re-associating anonymised data with a data owner, wherein the data owner has an associated private key, a public key and a personal code, the system comprising:
a. a service provider computer server for:
i. storing anonymised data,
ii. matching the public key with the personal code, and
iii. transferring the personal code to a user identification data computer server;
b. a third-party computer for accessing the anonymised data and for transferring the personal code to the service provider computer server; and
c. the user identification data computer server for matching the personal code to a data owner identifier.

24. The system according to claim 23, further comprising a data provider computer server for transferring the anonymised data to the service provider computer server.

25. The system according to claim 24, further comprising a personal computing device of the data owner for
a. generating the private key, the public key and the personal code;
b. transferring the public key exclusively to the service provider computer server; and
c. transferring the personal code to the user identification data computer server, the data provider computer server, the service provider computer server and the third-party computer.

26. Use of the method of claim 15 for storage of at least one of health data and electoral data.

27. A computer program comprising instructions which, when the program is executed by a computer, cause the computer to carry out the method of claim 15.

28. A computer-readable medium comprising instructions which, when executed by a computer, cause the computer to carry out the method of claim 15.
